(19) United States
(12) Patent Application Publication
(10) Pub. No.: US 2013/0280123 A1
(43) Pub. Date: Oct. 24, 2013

(54) METHOD FOR PREVENTING THE COLLAPSE OF HIGH ASPECT RATIO STRUCTURES DURING DRYING

(71) Applicants: Tianniu Chen, Rocky Hill, CT (US); Steven Bilodeau, Oxford, CT (US); Chimin Sheu, Hsin Chu (TW); Mutsumi Nakanishi, Kyoto (JP); Masahiro Matsuoka, Kyoto (JP); Fumio Nakayama, San Jose, CA (US); Peng Zhang, Montvale, NJ (US); Michael B. Korzenski, Danbury, CT (US); Emanuel I. Cooper, Scarsdale, NY (US); Kate Veccharelli, Danbury, CT (US); Makonnen Payne, San Jose, CA (US)

(72) Inventors: Tianniu Chen, Rocky Hill, CT (US); Steven Bilodeau, Oxford, CT (US); Chimin Sheu, Hsin Chu (TW); Mutsumi Nakanishi, Kyoto (JP); Masahiro Matsuoka, Kyoto (JP); Fumio Nakayama, San Jose, CA (US); Peng Zhang, Montvale, NJ (US); Michael B. Korzenski, Danbury, CT (US); Emanuel I. Cooper, Scarsdale, NY (US); Kate Veccharelli, Danbury, CT (US); Makonnen Payne, San Jose, CA (US)

(73) Assignee: ADVANCED TECHNOLOGY MATERIALS, INC., Danbury, CT (US)

(21) Appl. No.: 13/819,249

(22) PCT Filed: Aug. 26, 2011
(86) PCT No.: PCT/US11/49347

§ 371 Date: Jul. 11, 2013

Related U.S. Application Data
(60) Provisional application No. 61/377,689, filed on Aug. 27, 2010.
(60) Provisional application No. 61/378,548, filed on Aug. 31, 2010.
(60) Provisional application No. 61/437,352, filed on Jan. 28, 2011.
(60) Provisional application No. 61/437,340, filed on Jan. 28, 2011.
(60) Provisional application No. 61/476,029, filed on Apr. 15, 2011.
(60) Provisional application No. 61/492,880, filed on Jun. 3, 2011.

(51) Int. Cl. C09C 3/08

(52) U.S. Cl. CPC C09C 3/08
USPC 422/1; 252/380

(57) ABSTRACT

Methods of reducing the capillary forces experienced by fragile high aspect ratio structures during drying to substantially prevent damage to said high aspect ratio structures during drying. They include modifying the surface of the high aspect ratio structures such that the forces are sufficiently minimized and as such less than 10% of the high aspect ratio features will have bent or collapsed during drying of the structure having said features thereon.

### CROSS REFERENCE TO RELATED APPLICATIONS

This application claims priority to U.S. Provisional Patent Application No. 61/377,689 filed Aug. 27, 2010 in the name of Steven Bilodeau et al. entitled “Method for Preventing the Collapse of High Aspect Ratio Structures During Drying,” to U.S. Provisional Patent Application No. 61/437,352 filed Jan. 28, 2011 in the name of Steven Bilodeau et al. entitled “Method for Preventing the Collapse of High Aspect Ratio Structures During Drying,” to U.S. Provisional Patent Application No. 61/378,548 filed Aug. 31, 2010 in the name of Tianniu Chen et al. entitled “Method for Preventing the Collapse of High Aspect Ratio Structures During Drying,” to U.S. Provisional Patent Application No. 61/437,340 filed Jan. 28, 2011 in the name of Tianniu Chen et al. entitled “Method for Preventing the Collapse of High Aspect Ratio Structures During Drying,” to U.S. Provisional Patent Application No. 61/476,029 filed Apr. 15, 2011 in the name of Tianniu Chen entitled “Method for Preventing the Collapse of High Aspect Ratio Structures During Drying,” and to U.S. Provisional Patent Application No. 61/492,880 filed Jun. 3, 2011 in the name of Tianniu Chen entitled “Method for Preventing the Collapse of High Aspect Ratio Structures During Drying,” each of which is incorporated by reference herein in their entirety.

### FIELD

The present invention relates to methods for cleaning/drying high aspect ratio structures, wherein the collapse of said structures during drying is substantially prevented.

### DESCRIPTION OF THE RELATED ART

There is an ongoing trend in semiconductor device design to use dense arrays of high aspect ratio structures with narrow features. When wet processes are used with these types of structures, the capillary forces present during drying often cause distortion and even collapse of the features. These distortions can interfere with device operation. Specifically, this is a severe problem during the wet etching of the DRAM or flash memory storage nodes and limits scaling more aggressive geometries such as 25 nm and below. It is also expected to be an issue for cleaning STI (shallow trench isolation) features, gate transistors, contacts, first metal layers, MEMS (microelectromechanical systems) structures and some photovoltaic structures (such as silver solar cells).

The capillary forces within high aspect ratio structures are described by the Young-Laplace equation, wherein said forces are proportional to both the air/liquid surface tension of the liquid within the structure and the cosine of the contact angle between the liquid and the feature surface. Other interfacial phenomena include long-range electric double-layer forces and oscillatory solvation forces. Most current approaches to avoid capillary damage use low surface tension liquids, which can significantly reduce capillary forces relative to water. That said, distortions and collapse still occur during drying using the compositions and methods of the prior art.

### SUMMARY

The present invention generally relates to methods of preventing damage to high aspect ratio structures during drying. More specifically, the present invention relates to methods of modifying the surface of the features such that the contact angle of a composition at said modified surface is about 90 degrees.

In one aspect, a method of modifying a surface of a high aspect ratio feature, said method comprising:

contacting the surface of the high aspect ratio feature with an additive composition to produce a modified surface,
wherein forces acting on the high aspect ratio feature when a rinse solution is in contact with the modified surface are sufficiently minimized to prevent bending or collapse of the high aspect ratio feature at least during removal of the rinse solution or at least during drying of the high aspect ratio feature.

In another aspect, an article of manufacture is described, said article comprising an additive composition and a modified surface, wherein the additive composition comprises at least one surfactant, at least one organic solvent, optionally at least one co-surfactant, optionally at least one defoamer, optionally at least one buffering agent, and at least one stabilizing agent.

In still another aspect, an article of manufacture is described, said article comprising a modified high aspect ratio surface, said modified surface comprising adsorbed surfactant compounds and a rinse solution, wherein said composition in contact with the modified surface has a contact angle in a range from about 70 degrees to about 110 degrees, and wherein the modified high aspect ratio surface comprises doped monocrystalline silicon, doped polycrystalline silicon, undoped monocrystalline silicon, undoped polycrystalline silicon, silicon oxide, silicon nitride, amorphous carbon, gallium nitride, titanium nitrides, tantalum nitrides, tungsten nitrides, cobalt silicides, nickel silicides, ruthenium, ruthenium oxide, other ruthenium-containing compounds, or combinations thereof.

In still another aspect, an article of manufacture is described, said article comprising a modified high aspect ratio surface, said modified surface comprising adsorbed surfactant compounds and a rinse solution, wherein said composition in contact with the modified surface has a contact angle in a range from about 70 degrees to about 110 degrees, and wherein the modified high aspect ratio surface comprises titanium nitrides, ruthenium, ruthenium oxide, other ruthenium-containing compounds, or combinations thereof.

Other aspects, features, and advantages of the invention will be more fully apparent from the ensuing disclosure and appended claims.

### BRIEF DESCRIPTION OF THE DRAWINGS

FIG. 1 is a schematic of the method of preventing damage to high aspect ratio structures during drying.

FIGS. 2a and b illustrate the contact angles of DI water on blanket TiNx (ALD) treated with different formulations.

FIG. 3 illustrates the general process flow for evaluating the contact angle of modified Ru surfaces.

FIG. 4 illustrates the contact angles of DI water on blanket Ru (ALD) treated with different formulations.

FIG. 5 illustrates the general process flow for evaluating the contact angle of modified polysilicon surfaces.

FIGS. 6a and b illustrate the contact angles of DI water on blanket polysilicon treated with different formulations.

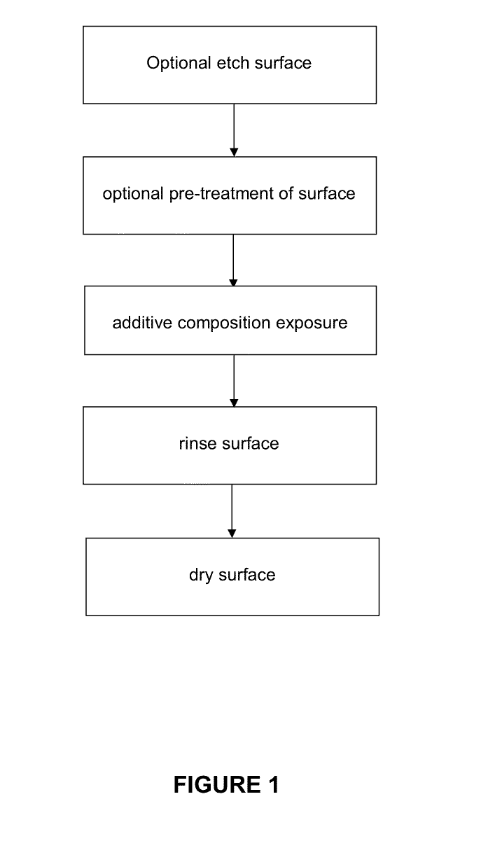

### DETAILED DESCRIPTION, AND PREFERRED EMBODIMENTS THEREOF

The present invention generally relates to methods of reducing the capillary forces experienced by fragile high aspect ratio structures during drying hence substantially preventing damage to said high aspect ratio structures during drying. More specifically, the present invention relates to methods of modifying the surface of the features such that the contact angle of a composition at said modified surface is about 90 degrees.

According to the Young-Laplace equation, Δp=2(γ) (cos θ)/r, when the contact angle (θ) of a surface approaches 90° and the surface tension (γ) of the composition in contact with the surface is minimized (e.g., by including surfactant(s) therein), the pressure difference (Δp) on each side of the high aspect ratio feature with radius of curvature (r) will approach zero, thus minimizing or preventing feature collapse. Towards that end, the present invention relates to a method of modifying the surface of high aspect ratio features so that a rinse solution in contact therewith will have a contact angle of about 90 degrees. Under these conditions, the capillary forces are expected to approach zero.

For ease of reference, “microelectronic device” corresponds to semiconductor substrates, flat panel displays, phase change memory devices, solar panels and other products including solar cell devices, photovoltaic, and microelectromechanical systems (MEMS), manufactured for use in microelectronic, integrated circuit, energy collection, or computer chip applications. It is to be understood that the terms “microelectronic device,” “microelectronic substrate” and “microelectronic device structure” are not meant to be limiting in any way and include any substrate or structure that will eventually become a microelectronic device or microelectronic assembly. The microelectronic device can be patterned, blanketed, a control and/or a test device.

As used herein, “about” is intended to correspond to ±5% of the stated value.

“The forces that are sufficiently minimized” is defined herein to correspond to the minimization of high aspect ratio feature bending or collapse. More specifically, less than 10% of the high aspect ratio features will have bent or collapsed during drying of the structure having said features thereon, more preferably less than 5% of the high aspect ratio features will have bent or collapsed during drying, even more particularly less than 2% of the high aspect ratio features will have bent or collapsed during drying, and most preferably less than 1% of the high aspect ratio features will have bent or collapsed during drying of the structure having said features thereon, based on the total area of features on said structure. “Bending” corresponds to any deviation of the feature relative to its spatial positioning prior to rinsing and includes touching or sticking of the features although it should be appreciated that the feature can be bent and not touching or sticking to another feature. “Collapse” corresponds to a more substantial deviation of features relative to the spatial positioning prior to rinsing wherein the features have undergone a domino effect (i.e., the collapse of one feature onto a second leads to the collapse of the second feature, etc.). Collapse can include the complete removal of the feature from the structure or just a partial collapse of the features onto each other.

As defined herein, a “high aspect ratio feature” corresponds to features on the microelectronic device wherein the aspect ratio (the ratio of the height of the feature relative to its width) is greater than 2:1, more preferably greater than 5:1 and even more preferably greater than 10:1. Features having a high aspect ratio include, but are not limited to, front end of the line (FEOL) features such as shallow trench isolation (STI) features, gate transistors, contacts, flash memory, and DRAM capacitors, back end of line (BEOL) features as well as other features found in related fields such as MEMS and photovoltaic cell applications (such as sliver solar cells).

As defined herein, a “rinse solution” corresponds to a composition having a surface tension equal to or lower than water (72.8 dynes/cm), preferably in a range from about 72.8 dynes/cm to about 65 dynes/cm, more preferably from about 72.8 dynes/cm to about 70 dynes/cm.

As defined herein, “removing sacrificial materials such as oxides from the surface of the high aspect ratio feature” corresponds to the removal of sacrificial materials such as oxides from the microelectronic device to expose the surface of the high aspect ratio feature, regardless of the thickness of the sacrificial materials such as oxides.

As defined herein, a “low drying force,” which corresponds to the Δp in the aforementioned Young-Laplace equation, corresponds to a low Δp wherein the contact angle θ is preferably approaching 90 degrees and/or the surface tension γ of the liquid is preferably lowered. Because of the numerous variations, a low capillary force corresponds to a capillary force that is low enough that the high aspect ratio feature does not bend or collapse during drying, as readily determined by the skilled artisan.

As used herein, “residue” corresponds to particles generated during the manufacture of a microelectronic device including, but not limited to, plasma etching, ashing, wet etching, and combinations thereof.

As used herein, “contaminants” correspond to chemicals, excluding residue, present on the surface of the microelectronic device subsequent to the plasma etching, ashing, or wet etching, reaction and chemical by-products, and any other materials that are the by-products of said processes. Typically, contaminants will be organic in nature.

As defined herein, “post-etch residue” corresponds to material remaining following gas-phase plasma etching processes, e.g., BEOL dual damascene processing. The post-etch residue may be organic, organometallic, oligomeric/polymeric, or inorganic in nature, for example, silicon-containing material, carbon-based organic material, and etch gas residue such as oxygen and fluorine.

As defined herein, “post-ash residue,” as used herein, corresponds to material remaining following oxidative or reductive plasma ashing to remove hardened photoresist and/or bottom anti-reflective coating (BARC) materials. The post-ash residue may be organic, organometallic, oligomeric/polymeric, or inorganic in nature.

“Dense fluid,” as used herein, corresponds to a supercritical fluid or a subcritical fluid. The term “supercritical fluid” is used herein to denote a material which is under conditions of not lower than a critical temperature, T_{c}, and not less than a critical pressure, P_{c}, in a pressure-temperature diagram of an intended compound. The preferred supercritical fluid employed is CO₂, which may be used alone or in an admixture with another additive such as Ar, NH₃, N₂, CH₄, C₂H₄, CHF₃, C₂H₆, n-C₃H₈, H₂O, N₂O and the like. The term “subcritical fluid” describes a solvent in the subcritical state, i.e., below the critical temperature and/or below the critical pressure associated with that particular solvent. Preferably, the subcritical fluid is a high pressure liquid of varying density.

DRAM cells are designed using various cell designs such as 4F², 6F², 8F², etc. The skilled artisan understands that for a cell design of 4F² (2F×2F) at a 50 nm process node (F=50), the pitch or on center distance from capacitor to capacitor is 100 nm (see, e.g., http://www.eetimes.com/electronics-news/4081855/The-50-nm-DRAM-battle-rages-on-An-overview-of-Micron-s-technology; U.S. Pat. No. 7,349,232).

In general, the invention described herein relates to a modifying a surface of a high aspect ratio feature, said method comprising contacting the surface with an additive composition to produce a modified surface; and contacting the modified surface with a rinse solution, wherein forces acting on the high aspect ratio feature when the rinse solution is in contact with the modified surface are sufficiently minimized to prevent bending or collapse of the high aspect ratio feature at least during removal of the rinse solution or during drying of the high aspect ratio feature. Forces acting on the high aspect ratio feature include, but are not limited to, the pressure difference on each side of the high aspect ratio feature (Δp). The surface of the high aspect ratio feature can comprise at least one of silicon (e.g., doped monocrystalline silicon, doped polycrystalline silicon, undoped monocrystalline silicon, undoped polycrystalline silicon, silicon oxide, silicon nitride, polysilicon), amorphous carbon, gallium nitride, titanium nitride, tantalum nitrides, tungsten nitride, cobalt silicides, nickel silicides, and/or ruthenium (e.g., ruthenium, ruthenium oxide, ruthenium nitride, other ruthenium-containing compounds), or any combination thereof.

### First Aspect

In a first aspect, a method of maintaining a contact angle on the surface of a high aspect ratio feature is described, said method comprising contacting a surface with an additive composition to produce a modified surface, wherein a rinse solution in contact with the modified surface has a contact angle in a range from about 70 degrees to about 110 degrees. Preferably, the contact angle is in a range from about 70 degrees to about 110 degrees, more preferably about 85 degrees to about 105 degrees, and most preferably between about 85 degrees and about 95 degrees. The surface of the high aspect ratio feature comprises gallium nitride, titanium nitride, amorphous carbon, tantalum nitrides, tungsten nitride, cobalt silicides, nickel silicides, polysilicon, silicon nitride, and/or ruthenium (e.g., ruthenium, ruthenium oxide, ruthenium nitride, other ruthenium-containing compounds), or any combination thereof. In one embodiment, the modified surface is rinsed with a rinse solution, wherein the contact angle of the modified surface at rinse time t=x is no greater than about +/− ten degrees different from the contact angle of the modified surface at rinse time t=0, wherein x is in a range from about 60 sec to about 600 sec or more. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof.

In one embodiment of the first aspect, a method of maintaining a contact angle on the surface of a high aspect ratio feature is described, said method comprising contacting gallium nitride, titanium nitride, amorphous carbon, tantalum nitrides, tungsten nitride, cobalt silicides, nickel silicides, polysilicon, silicon nitride, and/or a ruthenium-containing surface with an additive composition to produce a modified surface, and rinsing the modified surface with a rinse solution, wherein the rinse solution in contact with the modified surface has a contact angle in a range from about 70 degrees to about 110 degrees, more preferably about 85 degrees to about 105 degrees, and most preferably about 85 degrees and about 95 degrees. Preferably, the ruthenium-containing surface comprises ruthenium, ruthenium oxide, ruthenium nitride, other ruthenium-containing compounds, or any combination thereof. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof.

In another embodiment of the first aspect, a method of modifying a surface of a high aspect ratio feature is described, said method comprising contacting the surface with an additive composition to produce a modified surface, wherein a rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises gallium nitride, titanium nitride, amorphous carbon, tantalum nitrides, tungsten nitride, cobalt silicides, nickel silicides, polysilicon, silicon nitride, and/or ruthenium-containing compounds selected from the group consisting of ruthenium, ruthenium oxide, ruthenium nitride, other ruthenium-containing compounds, or any combination thereof. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof.

In still another embodiment of the first aspect, a method of modifying a surface of a high aspect ratio feature is described, said method comprising contacting the surface with an additive composition to produce a modified surface, and rinsing the modified surface with a rinse solution, wherein rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises gallium nitride, titanium nitride, amorphous carbon, tantalum nitrides, tungsten nitride, cobalt silicides, nickel silicides, polysilicon, silicon nitride, and/or ruthenium-containing compounds selected from the group consisting of ruthenium, ruthenium oxide, ruthenium nitride, other ruthenium-containing compounds, or any combination thereof. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof.

It should be appreciated that “maintaining a contact angle on the surface of a high aspect ratio feature during a rinse” and “modifying a surface of a high aspect ratio feature” is preferably done to substantially prevent high aspect ratio feature collapse.

For the purposes of the present disclosure, water is not considered an “organic solvent.”

The high aspect ratio surface can comprise gallium nitride, titanium nitride, amorphous carbon, tantalum nitrides, tungsten nitride, cobalt silicides, nickel silicides, polysilicon, silicon nitride, and/or ruthenium-containing compounds selected from the group consisting of ruthenium, ruthenium oxide, ruthenium nitride, other ruthenium-containing compounds, or any combination thereof. In one embodiment, the high aspect ratio surface comprises silicon nitride. In another embodiment, the high aspect ratio surface comprises ruthenium, for example, at least one of elemental ruthenium, ruthenium oxide, ruthenium nitride, and other ruthenium-containing compounds. In still another embodiment, the high aspect ratio comprises titanium nitride. It should be appreciated by the skilled artisan that the high aspect ratio surface may be pre-treated, depending on the surface to be dried, to remove contamination, residues, sacrificial materials, or combinations thereof prior to exposure to the additive composition. For example, when the high aspect ratio surface comprises titanium nitride, a sacrificial layer can be removed to produce a starting surface.

When necessary, a sacrificial oxide layer can be accomplished using a composition comprising a buffered oxide etch (BOE), e.g., a buffered HF solution or a dilute HF solution. Buffered HF solutions are preferably formulated by combining HF with ammonium fluoride in water (e.g., 5.5 wt. % HF (49 wt. % in water)+16.4 wt. % NH₄F (40 wt. %) in water)+79.1 wt. % water). It should be appreciated that the BOE is not limited to a buffered HF solution and that this specific buffered HF solution is proposed as an example and is not intended to limit the buffered HF solution in any way. It one embodiment, the composition used to remove a sacrificial oxide layer can further comprise a surfactant to improve the wetting of the BOE in the high aspect ratio structures. The resulting surface is preferably hydrophilic in nature. Conditions for the removal of a sacrificial oxide layer include temperature in a range from about 20° C. to about 80° C., preferably about 20° C. to about 30° C., wherein time is dependent on the thickness of the sacrificial oxide layer, the temperature, the concentration of the BOE or dilute HF solution, and the amount of stirring or agitation occurring, as readily determined by the skilled artisan. The composition comprising a BOE or a dilute HF solution is substantially devoid of hydrogen peroxide, sulfuric acid, and ammonia.

The surface preferably contains titanium nitride, ruthenium and/or silicon nitride, even more preferably titanium nitride or ruthenium, and is contacted with an additive composition to modify the surface energy of the high aspect ratio sidewalls and hence engineer a contact angle when a composition is contacted with said sidewalls. The additive composition comprises, consists of, or consists essentially of at least one surfactant, at least one solvent, optionally at least one co-surfactant, optionally at least one defoaming agent, optionally at least one buffering solution, and at least one stabilizing agent. Surfactants contemplated include, but are not limited to, acids and bases, non-ionic surfactants, anionic surfactants, cationic surfactants, zwitterionic surfactants, and combinations thereof. Preferred acidic or basic surfactants include, but are not limited to, surfactants having an acid or base functionality (“head”) and a straight-chained or branched hydrocarbon hydrophobic group (“tail”) and/or surfactants having an acidic functionality (“head”) and a perfluorinated hydrocarbon group (“tail”). Preferred acid or base functionalities include phosphoric, phosphonic, phosphonic monoesters, phosphate monoesters and diesters, carboxylic acids, dicarboxylic acid monoesters, tricarboxylic acid mono- and diesters, sulfate monoesters, sulfonic acids, amines, and salts thereof. The hydrocarbon groups preferably have at least 2, e.g., 2-30, carbon atoms (e.g., ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, etc.), except that somewhat shorter hydrocarbon groups of 2-20 carbons (e.g., ethyl, propyl, butyl, pentyl, hexyl, 2-ethylhexyl, dodecyl) are preferred where the molecule contains two alkyl chains such as in phosphate diesters and phosphate monoesters. The perfluorinated hydrocarbon groups preferably have 7-14 carbon atoms (e.g., heptyl, octyl, nonyl, decyl, undecyl, dodecyl, tridecyl, tetradecyl). In another embodiment, the surfactant comprises a compound having the formula (R¹)(R²)P(═O)(R³), wherein R¹, R² and R³ are independent from one another and are selected from the group consisting of hydrogen, hydroxyl, C₁-C₃₀ alkyls, C₂-C₃₀ alkenes, cycloalkyls, C₂-C₃₀ alkoxys, or any combination thereof. In yet another embodiment, the surfactant comprises a compound having the formula (R¹R²R³R⁴)NX, wherein R¹, R², R³, and R⁴, are independent from one another and are selected from the group consisting of hydrogen, C₁-C₃₀ alkyls, C₂-C₃₀ alkenes, cycloalkyls, C₁-C₃₀ alkoxys, C₁-C₃₀ carboxylates, or any combination thereof, and wherein X is any anion having a −1 charge. In still another embodiment, the surfactant comprises a compound having the formula [(R¹)(R²)N]C(═O)(CR³R⁴)ₙC(═O)[N(R⁵)(R⁶)], wherein R¹, R², R³, R⁴, R⁵, and R⁶ are independent from one another and are selected from the group consisting of hydrogen, C₂-C₃₀ alkyls, C₂-C₃₀ alkenes, cycloalkyls, C₂-C₃₀ alkoxys, C₂-C₃₀ carboxylates, or any combination thereof, and wherein n=any integer from 1-12. In another embodiment, the surfactant comprises a carboxylic acids with the formula R¹C(═O)(OH) or R¹C(═O)(OH)(CH₂)ₙ(O═)(HO)CR², wherein R¹ or R² are selected from C₁-C₃₀ alkyl or C₂-C₃₀ alkylene chains, preferably C₁-C₂₀ alkyl or C₂-C₂₀ alkylene chains, n are integers between 0 and 20. Preferred surfactants include at least one of decylphosphonic acid, dodecylphosphonic acid (DDPA), tetradecylphosphonic acid, hexadecylphosphonic acid, bis(2-ethylhexyl)phosphate, octadecylphosphonic acid, perfluoroheptanoic acid, prefluorodecanoic acid, trifluoromethanesulfonic acid, phosphonoacetic acid, dodecylbenzenesulfonic acid, dodecenylsuccinic acid, dioctadecyl hydrogen phosphate, octadecyl dihydrogen phosphate, dodecylamine, dodecenylsuccinic acid monodiethanol amide, lauric acid, palmitic acid, oleic acid, juniperic acid, 12 hydroxystearic acid, octadecylphosphonic acid (ODPA), most preferably dodecylphosphonic acid, octadecylphosphonic acid, or a combination thereof.

Non-ionic surfactants contemplated include, but are not limited to, polyoxyethylene lauryl ether (Emalmin NL-100 (Sanyo), Brij 30, Brij 98), dodecenylsuccinic acid monodiethanol amide (DSDA, Sanyo), ethylenediamine tetrakis(ethoxylate-block-propoxylate) tetrol (Tetronic 90R4), polyoxyethylene polyoxypropylene glycol (Newpole PE-68 (Sanyo), Pluronic L31, Pluronic 31R1), polyoxypropylene sucrose ether (SN0085, Sanyo), t-octylphenoxypolyethoxyethanol (Triton X100), Polyoxyethylene (9) nonylphenylether, branched (IGEPAL CO-250), polyoxyethylene sorbitol hexaoleate, polyoxyethylene sorbitol tetraoleate, polyethylene glycol sorbitan monooleate (Tween 80), sorbitan monooleate (Span 80), alkyl-polyglucoside, ethyl perfluorobutyrate, 1,1,3,3,5,5-hexamethyl-1,5-bis[2-(5-norbornen-2-yl)ethyl]trisiloxane, monomeric octadecylsilane derivatives such as SIS6952.0 (Siliclad, Gelest), siloxane modified polysilazane such as PP1-SG10 Siliclad Glide 10 (Gelest), silicone-polyether copolymers such as Silwet L-77 (Setre Chemical Company), and Silwet ECO Spreader (Momentive).

Cationic surfactants contemplated include, but are not limited to, heptadecanefluorooctane sulfonic acid tetraethylammonium, stearyl trimethylammonium chloride (Econol TMS-28, Sanyo), 4-(4-diethylaminophenylazo)-1-(4-nitrobenzyl)pyridium bromide, cetylpyridinium chloride monohydrate, benzalkonium chloride, benzethonium chloride benzyldimethyldodecylammonium chloride, benzyldimethylhexadecylammonium chloride, hexadecyltrimethylammonium bromide, dimethyldioctadecylammonium chloride, dodecyltrimethylammonium chloride, hexadecyltrimethylammonium p-toluenesulfonate, didodecyldimethylammonium bromide, di(hydrogenated tallow)dimethylammonium chloride, tetraheptylammonium bromide,tetrakis(decyl)ammonium bromide, Aliquat® 336 and oxyphenonium bromide, guanidine hydrochloride (C(NH₂)₃Cl) or triflate salts such as tetrabutylammonium trifluoromethanesulfonate. The hydrocarbon groups preferably have at least 10, e.g., 10-20, carbon atoms (e.g., decyl, undecyl, dodecyl, tridecyl, tetradecyl, pentadecyl, hexadecyl, heptadecyl, octadecyl, nonadecyl, eicosyl), except that somewhat shorter hydrocarbon groups of 6-20 carbons (e.g. hexyl, 2-ethylhexyl, dodecyl) are preferred where the molecule contains two functionalized alkyl chains such as in dimethyldioctadecylammonium chloride, dimethyldihexadecylammonium bromide and di(hydrogenated tallow)dimethylammonium chloride (e.g., Arquad 2HT-75, Akzo Nobel). Preferably, dimethyldioctadecylammonium chloride, di(hydrogenated tallow)dimethylammonium chloride, or a combination thereof are used.

Anionic surfactants contemplated include, but are not limited to, sodium polyoxyethylene lauryl ether, sodium dihexylsulfosuccinate, dicyclohexyl sulfosuccinate sodium salt, sodium 7-ethyl-2-methyl-4-undecyl sulfate (Tergitol 4), SODOSIL RM02, and phosphate fluorosurfactants such as Zonyl FSJ.

Zwitterionic surfactants include, but are not limited to, ethylene oxide alkylamines (AOA-8, Sanyo), N,N-dimethyldodecylamine N-oxide, sodium cocaminpropinate (LebonApl-D, Sanyo), 3-(N,N-dimethylmyristylammonio)propanesulfonate, and (3-(4-heptyl)phenyl-3-hydroxypropyl)dimethylammoniopropanesulfonate.

Although not wishing to be bound by theory, it is thought that the head functional groups interact with the high aspect ratio surface while the hydrophobic tails engineer the contact angle in a range from about 70 to about 110 degrees, i.e., the surfactant forms a coating on the surface of the high aspect ratio structure. Conditions for the contact of the additive composition with the surface include temperature in a range from about 20° C. to about 120° C., preferably about 20° C. to about 80° C., and more preferably about 20° C. to about 30° C., for a cumulative time in a range from about 1 min to about 100 min, preferably about 1 min to about 10 min, and more preferably about 3 min to about 8 min, wherein the additive composition may be contacted with the surface in one application or upwards of five applications. The concentration of surfactant in the additive composition is preferably in a range from about 0.1 wt. % to about 10 wt. %, more preferably in a range from about 1 wt. % to about 5 wt. %. It should be appreciated that the exposure may be static or dynamic or a mixture of both as readily determined by the skilled artisan. Although not wishing to be bound by theory, it is either thought that the surfactant in the additive composition can be physically or chemically adsorbed at the surface thereby modifying the surface.

The additive composition for use in the method of the first aspect includes at least one solvent, wherein said solvent is chosen to ensure high solubility of the at least one surfactant therein, as well as to assist with the wetting of the surface. Preferably, at least one of the solvents has the formula R¹R²R³C(OH), where R¹, R² and R³ are independent from each other and are selected from to the group consisting of hydrogen, C₂-C₃₀alkyls, C₂-C₃₀alkenes, cycloalkyls, C₂-C₃₀alkoxys, and combinations thereof. Solvents contemplated include, but are not limited to, water, alcohols, alkylenes, silyl halides, carbonates (e.g., alkyl carbonates, alkylene carbonates, etc.), glycols, glycol ethers, hydrocarbons, hydrofluorocarbons, and combinations thereof, such as straight-chained or branched methanol, ethanol, isopropanol (IPA), butanol, pentanol, hexanol, 2-ethyl-1-hexanol, heptanol, octanol, and higher alcohols (including diols, triols, etc.), 4-methyl-2-pentanol, ethylene glycol, propylene glycol, butylene glycol, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether (PGME), dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, 2,3-dihydrodecafluorpentane, ethyl perfluorobutylether, methyl perfluorobutylether, and combinations thereof. Preferably, the at least one solvent comprises 4-methyl-2-pentanol, TPGME, octanol, 2-ethyl-1-hexanol, isopropanol, and any combination thereof including 4-methyl-2-pentanol and TPGME or IPA and TPGME. The concentration of solvent in the additive composition is preferably in a range from about 10 wt % to about 99.9 wt. %, more preferably in a range from about 50 wt. % to about 99.9 wt. %, and most preferably in a range from about 90 wt. % to about 99.9 wt. %. In one embodiment, the additive composition includes at least two solvents. In another embodiment, the additive composition includes at least two organic solvents.

In another embodiment, the at least one solvent comprises a dense fluid such as supercritical carbon dioxide. In another embodiment, the additive composition further comprises at least one co-surfactant, at least one defoaming agent and/or at least one buffering agent in addition to the at least one solvent. Co-surfactants contemplated include ethoxylated nonylphenols such as EMULMIN 240 (Sanyo Chemical Industries, Ltd.), alkyl ethoxylates such as Brij 30, medium length n-alcohols such as butanol and higher alcohols (diols, triols, etc.), non-ionic surfactants such as polyethylene glycol/polypropylene glycol copolymers, polyethylene glycol sorbitan monooleate (Tween 80), and sorbitan monooleate (Span 80). and ethyloxylated fatty acids such as the IONET series (Sanyo Chemical Industries, Ltd.) such as IONET MS-400 (polyethylene glycol monostearate), IONET MS-1000 (polyethylene glycol monostearate), IONET MO-200 (polyethylene glycol monooleate), IONET MO-400 (polyethylene glycol monooleate), IONET MO-600 (polyethylene glycol monooleate), IONET DL-200 (polyethylene glycol distearate), IONET DS-300 (polyethylene glycol distearate), IONET DS-400 (polyethylene glycol distearate), IONET DS-4000 (polyethylene glycol distearate), IONET DO-400 (polyethylene glycol dioleate), IONET DO-600 (polyethylene glycol dioleate), and IONET DO-1000 (polyethylene glycol dioleate). When present, the amount of co-surfactant is determined by the additive HLB (hydrophilic lipophilic ratio) values and preferably in a range from about 0.1 wt. % to about 5 wt. %, preferably about 0.5 wt. % to about 3 wt. %.

Defoaming agents contemplated include species selected from the group consisting of ethylene oxide/propylene oxide block copolymers, alcohol alkoxylates, fatty alcohol alkoxylates, non-silicone water soluble defoamers such as Defoamer A (RD Chemical Company, Mountain View, Calif.), phosphoric acid ester blends with non-ionic emulsifiers, and combinations thereof. When present, the amount of defoaming agent is preferably in a range from about 0.001 wt % to about 2 wt. %, preferably about 0.01 wt. % to about 1 wt. %. Preferably, the defoaming agent comprises Defoamer A.

Stabilizing agents can be added to the additive composition to increase the solubility of the at least one surfactant, to improve the stability of the composition, improve the rinsability of the additive composition and/or to provide a more robust hydrophobic coating. Stabilizing agents include carboxylic acids having the formula R¹C(═O)OH, wherein R¹ is selected from C₁₂-C₂₄ alkyl or C₁₂-C₂₄ alkylene chains, preferably C₁₆-C₂₀ alkyl or C₁₆-C₂₀ alkylene chains, including lauric acid, palmitic acid, oleic acid, juniperic acid and 12 hydroxystearic acid. Alternatively or in addition, the stability agents can include guanidine HCl, triflate salts such as tetrabutylammonium trifluoromethanesulfonate, isopropyl alcohol, and/or water.

It should be appreciated that the additive composition can further include at least one free radical species, at least one ion exchange resin, at least one drying agent, or any combination of the three. The free radical species can be selected from the group consisting of hydroquinone, butylated hydroxyl toluene (BHT), butylated hydroanisole (BHA), diphenylamine, and combinations thereof. The at least one ion exchange resin can include MSC-1 (Dow Chemical). The at least one drying agent can include phosphoric anhydride.

In one embodiment of the first aspect, the additive composition comprises, consists of, or consists essentially of surfactant and at least one solvent. In another embodiment of the first aspect, the additive composition comprises, consists of, or consists essentially of surfactant, at least one solvent, and at least one co-surfactant. In still another embodiment of the first aspect, the additive composition comprises, consists of, or consists essentially of surfactant, at least two solvents, and at least one defoaming agent. In another embodiment of the first aspect, the additive composition comprises, consists of, or consists essentially of surfactant and at least two solvents. In yet another embodiment of the first aspect, the additive composition comprises, consists of, or consists essentially of surfactant, at least one solvent, and at least one defoaming agent. In another embodiment of the first aspect, the additive composition comprises, consists of, or consists essentially of surfactant, at least two organic solvents, and at least one defoaming agent. In another embodiment of the first aspect, the additive composition comprises, consists of, or consists essentially of surfactant and at least two organic solvents.

Preferably, the additive composition of the first aspect has the following properties: following interaction with the surface and the formation of a coating thereon, the surface has a contact angle of about 85 to about 95 degrees, preferably about 90 degrees, for the rinse solution; the additive composition wets the high aspect ratio structure surface; the contact angle is preferably maintained after rinsing with the rinse solution (e.g., the contact angle of the modified surface at rinse time t=x is no greater than about +/− ten degrees different from the contact angle of the modified surface at rinse time t=0, wherein x is in a range from about 60 sec to about 300 sec or more); the additive coating preferably results in minimal contamination (e.g., only a monolayer of surfactant remains after rinsing); and a balanced pH value to achieve the desired surface electrokinetic conditions based on PZC or IEP properties of different surfaces. Further, the additive composition is substantially devoid of stearic acid, myristic acid, and silane coupling agents such as hexamethyldisilazane and tetramethyl silyl diethylamine and no esterfication of silane coupling agents at the surface are necessary to effectuate the method of the first aspect described herein. “Substantially devoid” is defined herein as less than 2 wt. %, preferably less than 1 wt. %, more preferably less than 0.5 wt. %, most preferably less than 0.1 wt. %, and most preferably 0 wt %, based on the total weight of the composition.

For the purposes of the present disclosure, “contacting” includes, but is not limited to, spraying the additive composition on the surface, by dipping (in a volume of the additive composition), by contacting the surface with another material, e.g., a pad, or fibrous sorbent applicator element, that is saturated with the additive composition, by contacting the surface with an additive circulating composition, or by any other suitable means, manner or technique, by which the additive composition is brought into contact with the surface of the high aspect ratio feature. In one embodiment, the additive solution is pre-mixed and delivered to the wet process tool. In another embodiment, the additive solution is blended in situ in the wet process tool.

It should be appreciated that the device may be rinsed prior to the contact of the surface with an additive composition. Conditions for the pre-rinse include temperature in a range from about 20° C. to about 80° C., preferably about 20° C. to about 30° C., for time in a range from about 2 min to about 15 min, as readily determined by the skilled artisan.

Subsequent to contacting the surface with an additive composition to produce a modified surface, the modified surface is rinsed with a rinse solution to remove any additive that has not interacted with or coated the surface. The rinse solution can comprise at least one or a combination of the aforementioned solvents. Alternatively, the rinse solution can comprise, consist of, or consist essentially of at least one solvent, optionally at least one free radical species, optionally at least one ion exchange resin, and optionally at least one drying agent. The at least one free radical species can be selected from the group consisting of hydroquinone, butylated hydroxyl toluene (BHT), butylated hydroanisole (BHA), diphenylamine, and combinations thereof. The at least one ion exchange resin can include MSC-1 (Dow Chemical). The at least one drying agent can include phosphoric anhydride. Conditions for the rinse include temperature in a range from about 20° C. to about 80° C., preferably about 20° C. to about 30° C., for time in a range from about 1 min to about 20 min or more, preferably about 5 min to about 15 min. Proposed rinse solutions include water, IPA, TPGME, DPGME, the aforementioned co-surfactants, water, and combinations thereof. Alternatively or in addition, subsequent to contact of the surface with the additive composition, the surface can be irradiated or heated to treat the surface.

In still another embodiment, the method of the first aspect can further include drying the modified surface subsequent to rinsing. Drying may be effectuated using a spin dry; vapor drying using isopropanol (IPA), Novec 7100 fluid (3M), or other non-flammable solvent mixtures known in the art; or drying using a nitrogen gun. Thereafter, the additive interacting with or coating the surface can be removed (e.g., thermally). Following the removal of the additive layer, e.g., surfactant layer, the surface is preferably intact, clean, and ready for deposition of layers (e.g., dielectric layers).

Accordingly, in another embodiment of the first aspect, a method of modifying the surface of a high aspect ratio feature is described, said method comprising contacting the surface with an additive composition to produce a modified surface, rinsing the modified surface with a rinse solution, and drying the modified surface, wherein the rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises gallium nitride, titanium nitride, amorphous carbon, tantalum nitrides, tungsten nitride, cobalt silicides, nickel silicides, polysilicon, silicon nitride, and/or ruthenium-containing compounds selected from the group consisting of ruthenium, ruthenium oxide, ruthenium nitride, other ruthenium-containing compounds, or any combination thereof. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof. In still another embodiment of the first aspect, a method of modifying the surface of a high aspect ratio feature is described, said method comprising rinsing the surface, contacting the surface with an additive composition to produce a modified surface, rinsing the modified surface with a rinse solution, optionally drying the modified surface, and optionally removing the additive from the modified surface, wherein the rinse solution in contact with the modified surface has a contact angle in a range from about 70 degrees to about 110 degrees, more preferably about 85 degrees to about 95 degrees. Preferably, the surface of the high aspect ratio feature comprises gallium nitride, titanium nitride, amorphous carbon, tantalum nitrides, tungsten nitride, cobalt silicides, nickel silicides, polysilicon, silicon nitride, and/or ruthenium-containing compounds selected from the group consisting of ruthenium, ruthenium oxide, ruthenium nitride, other ruthenium-containing compounds, or any combination thereof. Preferably, the additive composition is blended in situ in the wet process tool. Preferably, the surface of the high aspect ratio feature comprises titanium nitride, and/or ruthenium (e.g., ruthenium, ruthenium oxide, ruthenium nitride, other ruthenium-containing compounds), or any combination thereof. Another embodiment of the first aspect relates to an article of manufacture comprising an additive composition and a modified surface, wherein the additive composition comprises at least one surfactant, at least one organic solvent, optionally at least one co-surfactant, optionally at least one defoaming agent, optionally a buffering agent, and at least one stability agent.

Still another aspect relates to an article of manufacture comprising a modified high aspect ratio surface, said modified surface comprising adsorbed surfactant compounds and a rinse solution, wherein said composition in contact with the modified surface has a contact angle in a range from about 70 degrees to about 110 degrees, and wherein the modified high aspect ratio surface comprises gallium nitride, titanium nitride, amorphous carbon, tantalum nitrides, tungsten nitride, cobalt silicides, nickel silicides, polysilicon, silicon nitride and/or ruthenium-containing compounds selected from the group consisting of ruthenium, ruthenium oxide, ruthenium nitride, other ruthenium-containing compounds, or any combination thereof. Preferably, the surface of the high aspect ratio feature comprises titanium nitride, and/or ruthenium (e.g., ruthenium, ruthenium oxide, ruthenium nitride, other ruthenium-containing compounds), or any combination thereof. In still another embodiment, the modified surface is reset using thermal processing, reactive ion etching, or plasma-aided etching processes.

### Second Aspect

A second aspect of the invention corresponds to a method of maintaining a contact angle on the surface of a high aspect ratio feature, said method comprising contacting a surface with an additive composition to produce a modified surface, wherein a rinse solution in contact with the modified surface has a contact angle in a range from about 70 degrees to about 110 degrees. Preferably, the contact angle is in a range from about 70 degrees to about 110 degrees, more preferably about 85 degrees to about 105 degrees, and most preferably about 85 degrees and about 95 degrees. Preferably, the surface of the high aspect ratio feature comprises doped or undoped monocrystalline Si, doped or undoped polycrystalline Si, polysilicon, silicon dioxide, silicon nitride, or combinations thereof. In one embodiment, the modified surface is rinsed with a rinse solution, wherein the contact angle of the modified surface at rinse time t=x is no greater than about +/− ten degrees different from the contact angle of the modified surface at rinse time t=0, wherein x is in a range from about 60 sec to about 600 sec or more.

In one embodiment of the second aspect, a method of maintaining a contact angle on the surface of a high aspect ratio feature is described, said method comprising contacting a silicon-containing surface with an additive composition to produce a modified surface, and rinsing the modified surface with a rinse solution, wherein the rinse solution in contact with the modified surface has a contact angle in a range from about 70 degrees to about 110 degrees, more preferably about 85 degrees to about 105 degrees, and most preferably about 85 degrees and about 95 degrees. Preferably, the silicon-containing surface comprises doped or undoped monocrystalline Si, doped or undoped polycrystalline Si, polysilicon, silicon dioxide, silicon nitride, or combinations thereof.

In another embodiment of the second aspect, a method of modifying a surface of a high aspect ratio feature is described, said method comprising contacting the surface with an additive composition to produce a modified surface, wherein a rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises silicon-containing material, preferably doped or undoped monocrystalline Si, doped or undoped polycrystalline Si, polysilicon, silicon dioxide, silicon nitride, or combinations thereof.

In still another embodiment of the second aspect, a method of modifying a surface of a high aspect ratio feature is described, said method comprising contacting the surface with an additive composition to produce a modified surface, and rinsing the modified surface with a rinse solution, wherein rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises silicon-containing material, preferably doped or undoped monocrystalline Si, doped or undoped polycrystalline Si, polysilicon, silicon dioxide, silicon nitride, or combinations thereof.

In yet another embodiment of the second aspect, a method of modifying a surface of a high aspect ratio feature is described, said method comprising pre-treating the surface of the high aspect ratio feature to remove residue and/or contaminant material from the surface, contacting the surface with an additive composition to produce a modified surface, and rinsing the modified surface with a rinse solution, wherein the rinse solution in contact with modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises silicon-containing material, preferably doped or undoped monocrystalline Si, doped or undoped polycrystalline Si, polysilicon, silicon dioxide, silicon nitride, or combinations thereof. Pre-treatment can be accomplished using any residue removal means (e.g., wet treatment) known in the art. Although not wishing to be bound by theory, pre-treatment is performed to modify the hydrophobicity/hydrophilicity of the surface, to adjust the electrokinetic properties of the surface, and/or to oxidize or reduce the surface. For example, when the high aspect ratio surface comprising silicon-containing material was previously etched (e.g., to create trenches, lines, vias, etc. using a wet etch composition or dry etching means (e.g., reactive ion etch (RIE))), the surface may be treated with a post-etch residue removal composition known in the art to substantially remove the post-etch residue. When the high aspect ratio surface was previously ashed (e.g., to remove photoresist), the surface may be treated with a post-ash residue removal composition known in the art to substantially remove the post-ash residue. When a wet etch of the surface is performed to etch silicon-containing material, a reactive ion etch is contemplated to alter the exposed silicon-containing material.

It should be appreciated that when the process includes the pre-treatment step, the device may be rinsed subsequent to the removal of residue and/or contaminants from the surface of the high aspect ratio feature to produce the surface to be contacted with the additive composition. Conditions for the post pre-treatment rinse include temperature in a range from about 20° C. to about 80° C., preferably about 20° C. to about 30° C., for time in a range from about 2 min to about 15 min or more, as readily determined by the skilled artisan. The rinse solution preferably comprises water. Alternatively or in addition, prior to contact of the surface with the additive composition, the surface can be irradiated or heated to treat the surface.

The additive composition for the method of the second aspect comprises, consists of, or consists essentially of at least one surfactant, at least one solvent, optionally at least one co-surfactant, and optionally at least one defoaming agent. The species contemplated for each component are enumerated hereinabove in the first aspect of the invention. In one embodiment of the second aspect, the additive composition comprises, consists of, or consists essentially of surfactant and at least one solvent. In another embodiment of the second aspect, the additive composition comprises, consists of, or consists essentially of surfactant, at least one solvent, and at least one co-surfactant. In still another embodiment of the second aspect, the additive composition comprises, consists of, or consists essentially of surfactant, at least one solvent, and components known in the art to remove residue (e.g., post-etch residue removal composition). In still another embodiment of the second aspect, the additive composition comprises, consists of, or consists essentially of surfactant, at least one solvent, at least one co-surfactant and components known in the art to remove residue (e.g., post-etch residue removal composition). In other words, the pre-treatment of the surface and the additive treatment of the surface can be combined into one-step. It should be appreciated by the skilled artisan that all residue removal compositions known in the chemical arts to remove the specific type of residue are contemplated herein. It should further be appreciated that when the additive composition includes components known in the art to remove residue, the pre-treatment step as described herein may still be necessary or may be an optional step.

Preferably, the additive composition has the following properties: following interaction with the surface and the formation of a coating thereon, the surface has a contact angle of about 85 to about 95 degrees, preferably about 90 degrees, for the rinse solution; the additive composition wets the high aspect ratio structure surface; the contact angle is preferably maintained after rinsing with the rinse solution (e.g., the contact angle of the modified surface at rinse time t=x is no greater than about +/− ten degrees different from the contact angle of the modified surface at rinse time t=0, wherein x is in a range from about 60 sec to about 300 sec or more); the additive coating preferably results in minimal contamination (e.g., only a monolayer of surfactant remains after rinsing); and a balanced pH value to achieve the desired surface electrokinetic conditions based on PZC or IEP properties of different surfaces. Further, the additive composition is substantially devoid of stearic acid, myristic acid, silane coupling agents such as hexamethyldisilazane and tetramethyl silyl diethylamine

For the purposes of the present disclosure, “contacting” includes, but is not limited to, spraying the additive composition on the surface, by dipping (in a volume of the additive composition), by contacting the surface with another material, e.g., a pad, or fibrous sorbent applicator element, that is saturated with the additive composition, by contacting the surface with an additive circulating composition, or by any other suitable means, manner or technique, by which the additive composition is brought into contact with the surface of the high aspect ratio feature. In one embodiment, the additive solution is pre-mixed and delivered to the wet process tool. In another embodiment, the additive solution is blended in situ in the wet process tool.

Subsequent to contacting the surface with an additive composition to produce a modified surface, the modified surface is rinsed with a rinse solution to remove any additive that has not interacted with or coated the surface. The rinse solution can comprise at least one or a combination of the aforementioned solvents. Alternatively, the rinse solution can comprise, consist of, or consist essentially of at least one solvent, optionally at least one free radical species, optionally at least one ion exchange resin, and optionally at least one drying agent. The at least one free radical species can be selected from the group consisting of hydroquinone, butylated hydroxyl toluene (BHT), butylated hydroanisole (BHA), diphenylamine, and combinations thereof. The at least one ion exchange resin can include MSC-1 (Dow Chemical). The at least one drying agent can include phosphoric anhydride. Conditions for the rinse include temperature in a range from about 20° C. to about 80° C., preferably about 20° C. to about 30° C., for time in a range from about 1 min to about 20 min or more, preferably about 5 min to about 15 min. Proposed rinse solutions include water, IPA, TPGME, the aforementioned co-surfactants, water, and combinations thereof. Alternatively or in addition, subsequent to contact of the surface with the additive composition, the surface can be irradiated or heated to treat the surface.

In still another embodiment, the method of the second aspect can further include drying the modified surface subsequent to rinsing. Drying may be effectuated using a spin dry; vapor drying using isopropanol (IPA), Novec 7100 fluid (3M), or other non-flammable solvent mixtures known in the art; or drying using a nitrogen gun. Thereafter, the additive interacting with or coating the surface can be removed (e.g., thermally). Following the removal of the additive layer, e.g., surfactant layer, the surface is preferably intact, clean, and ready for deposition of layers (e.g., dielectric layers).

Accordingly, in another embodiment of the second aspect, a method of modifying the surface of a high aspect ratio feature is described, said method comprising pre-treating the surface of the high aspect ratio feature to remove residue and/or contaminant material from the surface, contacting the surface with an additive composition to produce a modified surface, rinsing the modified surface with a rinse solution, and drying the modified surface, wherein the rinse solution in contact with the modified surface has a contact angle in a range from about 70 degrees to about 110 degrees, more preferably about 85 degrees to about 105 degrees. Preferably, the surface of the high aspect ratio feature comprises doped or undoped monocrystalline Si, doped or undoped polycrystalline Si, polysilicon, silicon dioxide, silicon nitride, or combinations thereof. Pre-treatment can be accomplished using any residue removal means (e.g., wet treatment) known in the art.

Accordingly, in still another embodiment, a method of modifying the surface of a high aspect ratio feature is described, said method comprising pre-treating the surface of the high aspect ratio feature to remove residue and/or contaminant material from the surface, rinsing the surface subsequent to pre-treatment, contacting the surface with an additive composition to produce a modified surface, rinsing the modified surface with a rinse solution, drying the modified surface, wherein the rinse solution in contact with the modified surface has a contact angle in a range from about 70 degrees to about 110 degrees, more preferably about 85 degrees to about 105 degrees, and most preferably about 85 degrees and about 95 degrees. Preferably, the surface of the high aspect ratio feature comprises doped or undoped monocrystalline Si, doped or undoped polycrystalline Si, polysilicon, silicon dioxide, silicon nitride, or combinations thereof. Pre-treatment can be accomplished using any residue removal means (e.g., wet treatment) known in the art.

Still another aspect relates to an article of manufacture comprising a modified high aspect ratio surface, said modified surface comprising adsorbed surfactant compounds and a rinse solution, wherein said composition in contact with the modified surface has a contact angle in a range from about 70 degrees to about 110 degrees, and wherein the modified high aspect ratio surface comprises doped or undoped monocrystalline Si, doped or undoped polycrystalline Si, polysilicon, silicon dioxide, silicon nitride, or combinations thereof.

In still another embodiment, the modified surface is reset using thermal processing, reactive ion etching, or plasma-aided etching processes.

### Third Aspect

In a third aspect, additive compositions are described, said composition comprising, consisting of or consisting essentially of at least one surfactant, at least one solvent, optionally at least one co-surfactant, optionally at least one defoaming agent, optionally at least one buffering agent, and at least one stabilizing agent, wherein the additive composition modifies a surface of a high aspect ratio feature such that a rinse solution in contact with the modified surface has a contact angle in a range from about 70 degrees to about 110 degrees. Compositions of the invention may be embodied in a wide variety of specific formulations, using the components described herein. Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

The compositions described herein are easily formulated by simple addition of the respective ingredients and mixing to homogeneous condition. Furthermore, the compositions may be readily formulated as single-package formulations or multi-part formulations that are mixed at the point of use, preferably multi-part formulations. The individual parts of the multi-part formulation may be mixed at the tool or in a storage tank upstream of the tool. The concentrations of the respective ingredients may be widely varied in specific multiples of the composition, i.e., more dilute or more concentrated, and it will be appreciated that the compositions described herein can variously and alternatively comprise, consist or consist essentially of any combination of ingredients consistent with the disclosure herein.

In one embodiment, the additive composition comprises dodecylphosphonic acid. In another embodiment, the additive composition comprises tetradecylphosphonic acid. In still another embodiment, the additive composition comprises hexadecylphosphonic acid. In another embodiment, the additive composition comprises at least one glycol ether solvent and a surfactant selected from the group consisting of dodecylphosphonic acid, tetradecylphosphonic acid, and hexadecylphosphonic acid. In yet another embodiment, the additive composition comprises at least one glycol ether solvent, at least one defoaming agent, and a surfactant selected from the group consisting of dodecylphosphonic acid, tetradecylphosphonic acid, and hexadecylphosphonic acid. In another embodiment, the additive composition comprises an alcohol and a surfactant selected from the group consisting of dodecylphosphonic acid, tetradecylphosphonic acid, and hexadecylphosphonic acid. In another embodiment, the additive composition comprises an alcohol, at least one defoaming agent, and a surfactant selected from the group consisting of dodecylphosphonic acid, tetradecylphosphonic acid, and hexadecylphosphonic acid. In still another embodiment, the additive composition comprises tripropylene glycol methyl ether and a surfactant selected from the group consisting of dodecylphosphonic acid, tetradecylphosphonic acid, and hexadecylphosphonic acid. In still another embodiment, the additive composition comprises tripropylene glycol methyl ether, at least one defoaming agent, and a surfactant selected from the group consisting of dodecylphosphonic acid, tetradecylphosphonic acid, and hexadecylphosphonic acid. In another embodiment, the additive composition comprises tripropylene glycol methyl ether, polyethylene glycol/polypropylene glycol copolymer, and a surfactant selected from the group consisting of dodecylphosphonic acid, tetradecylphosphonic acid, and hexadecylphosphonic acid. In yet another embodiment, the additive composition comprises 4-methyl-2-pentanol, tripropylene glycol methyl ether, at least one defoaming agent, and a surfactant selected from the group consisting of dodecylphosphonic acid, tetradecylphosphonic acid, and hexadecylphosphonic acid. In another embodiment, the additive composition comprises isopropanol, tripropylene glycol methyl ether, at least one defoaming agent, and a surfactant selected from the group consisting of dodecylphosphonic acid, tetradecylphosphonic acid, and hexadecylphosphonic acid. In still another embodiment, the additive composition comprises octanol, at least one defoaming agent, and a surfactant selected from the group consisting of dodecylphosphonic acid, tetradecylphosphonic acid, and hexadecylphosphonic acid.

In another embodiment, the additive composition comprises dimethyldioctadecylammonium chloride. In another embodiment, the additive composition comprises dimethyldioctadecylammonium chloride and at least one glycol ether solvent. In still another embodiment, the additive composition comprises dimethyldioctadecylammonium chloride and dipropylene glycol methyl ether. In still another embodiment, the additive composition comprises dimethyldioctadecylammonium chloride, dipropylene glycol methyl ether and at least one defoaming agent. In another embodiment, the additive composition comprises dimethyldioctadecylammonium chloride, dipropylene glycol methyl ether, and polyethylene glycol/polypropylene glycol copolymer.

Alternatively, the additive composition comprises di(hydrogenated tallow)dimethylammonium chloride. In another embodiment, the additive composition comprises di(hydrogenated tallow)dimethylammonium chloride and at least one glycol ether. In yet another embodiment, the additive composition comprises di(hydrogenated tallow)dimethylammonium chloride and tripropylene glycol methyl ether. In another embodiment, the additive composition comprises di(hydrogenated tallow)dimethylammonium chloride, tripropylene glycol methyl ether, and at least one defoaming agent. In yet another embodiment, the additive composition comprises di(hydrogenated tallow)dimethylammonium chloride, tripropylene glycol methyl ether and polyethylene glycol/polypropylene glycol copolymer.

### Example 1

The general process flow of evaluating formulations on blanket TiNₓ (ALD) substrates:

### I. Surface Pretreatment:

a. Acetone rinse for 60 seconds
b. IPA rinse for 5 seconds
c. DI rinse, dipping, 1 second; flowing DI, 60 seconds
d. SC1 rinse (1 part of NH₄OH:1 part of H₂O₂:5 parts of DI) for 60 seconds
e. DI rinse, dipping, 1 second; flowing DI, 60 seconds
f. Diluted BOE rinse (6 parts of DI:1 part of BOE) for 60 seconds
g. DI rinse, dipping, 1 second; flowing DI, 60 seconds

### II. Surface Modification

a. Total immersion of 2×2 cm TiNₓ coupons (ALD) in beakers or F20 plates comprising the formulations below for 300 seconds at room temperature
b. DI rinse, dipping, 1 second; flowing DI, 60 seconds

### III: Drying and Measurement of Contact Angle

a. Spin and dry on a Laurel tool or dried under N₂
b. Measure contact angle of DI water on modified surfaces

The following formulations were prepared.

Formulation A: 0.5 wt % DDPA, 0.05 wt % defoamer A, 99.45 wt % TPGME
Formulation B: 0.5 wt % DDPA, 0.05 wt % of 0.1 wt % defoamer A in DPGME, 99.45 wt % DPGME
Formulation C: 0.5 wt % DDPA, 0.05 wt % of 0.1 wt % defoamer A in PGME, 99.45 wt % PGME
Formulation D: 0.5 wt % DDPA, 0.05 wt % of 0.1 wt % defoamer A in 4-methyl-2-pentanol, 99.45 wt % 4-methyl-2-pentanol
Formulation E: 0.5 wt % DDPA, 0.05 wt % of 0.1 wt % defoamer A in IPA, 99.45 wt % IPA
Formulation F: 0.5 wt % DDPA, 0.05 wt % of 0.25 wt % defoamer A in TPGME, 10 wt % DPGME, 89.45 wt % TPGME
Formulation G: 0.5 wt % DDPA, 0.05 wt % of 0.25 wt % defoamer A in TPGME, 30 wt % DPGME, 69.45 wt % TPGME
Formulation H: 0.5 wt % DDPA, 0.05 wt % of 0.25 wt % defoamer A in TPGME, 50 wt % DPGME, 49.45 wt % TPGME
Formulation I: 0.5 wt % DDPA, 0.05 wt % of 0.25 wt % defoamer A in TPGME, 70 wt % DPGME, 29.45 wt % TPGME
Formulation J: 0.5 wt % DDPA, 0.05 wt % of 0.25 wt % defoamer A in TPGME, 10 wt % PGME, 89.45 wt % TPGME
Formulation K: 0.5 wt % DDPA, 0.05 wt % of 0.25 wt % defoamer A in TPGME, 30 wt % PGME, 69.45 wt % TPGME
Formulation L: 0.5 wt % DDPA, 0.05 wt % of 0.25 wt % defoamer A in TPGME, 50 wt % PGME, 49.45 wt % TPGME
Formulation M: 0.5 wt % DDPA, 0.05 wt % of 0.25 wt % defoamer A in TPGME, 70 wt % PGME, 29.45 wt % TPGME
Formulation N: 0.5 wt % DDPA, 0.05 wt % of 0.25 wt % defoamer A in TPGME, 10 wt % 4-methyl-2-pentanol, 89.45 wt % TPGME
Formulation O: 0.5 wt % DDPA, 0.05 wt % of 0.25 wt % defoamer A in TPGME, 30 wt % 4-methyl-2-pentanol, 69.45 wt % TPGME
Formulation P: 0.5 wt % DDPA, 0.05 wt % of 0.25 wt % defoamer A in TPGME, 50 wt % 4-methyl-2-pentanol, 49.45 wt % TPGME
Formulation Q: 0.5 wt % DDPA, 0.05 wt % of 0.25 wt % defoamer A in TPGME, 70 wt % 4-methyl-2-pentanol, 29.45 wt % TPGME
Formulation R: 0.5 wt % DDPA, 0.05 wt % of 0.25 wt % defoamer A in TPGME, 10 wt % IPA, 89.45 wt % TPGME
Formulation S: 0.5 wt % DDPA, 0.05 wt % of 0.25 wt % defoamer A in TPGME, 30 wt % IPA, 69.45 wt % TPGME
Formulation T: 0.5 wt % DDPA, 0.05 wt % of 0.25 wt % defoamer A in TPGME, 50 wt % IPA, 49.45 wt % TPGME
Formulation U: 0.5 wt % DDPA, 0.05 wt % of 0.25 wt % defoamer A in TPGME, 70 wt % IPA, 29.45 wt % TPGME
Formulation V: 0.5 wt % DDPA, 0.05 wt % of 0.25 wt % defoamer A in TPGME, 10 wt % water, 89.45 wt % TPGME
Formulation W: 0.5 wt % DDPA, 0.05 wt % of 0.25 wt % defoamer A in TPGME, 30 wt % water, 69.45 wt % TPGME
Formulation X: 0.5 wt % DDPA, 0.05 wt % of 0.25 wt % defoamer A in TPGME, 50 wt % water, 49.45 wt % TPGME

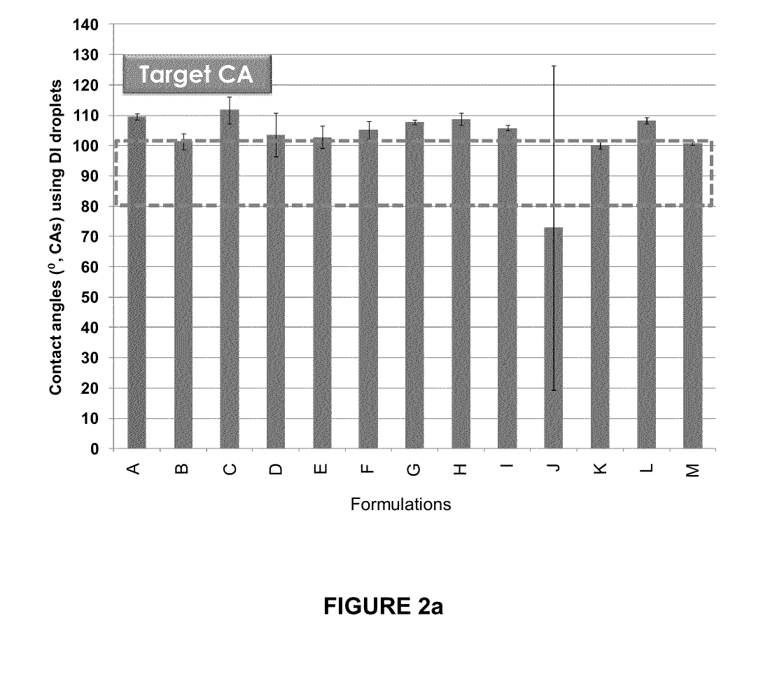

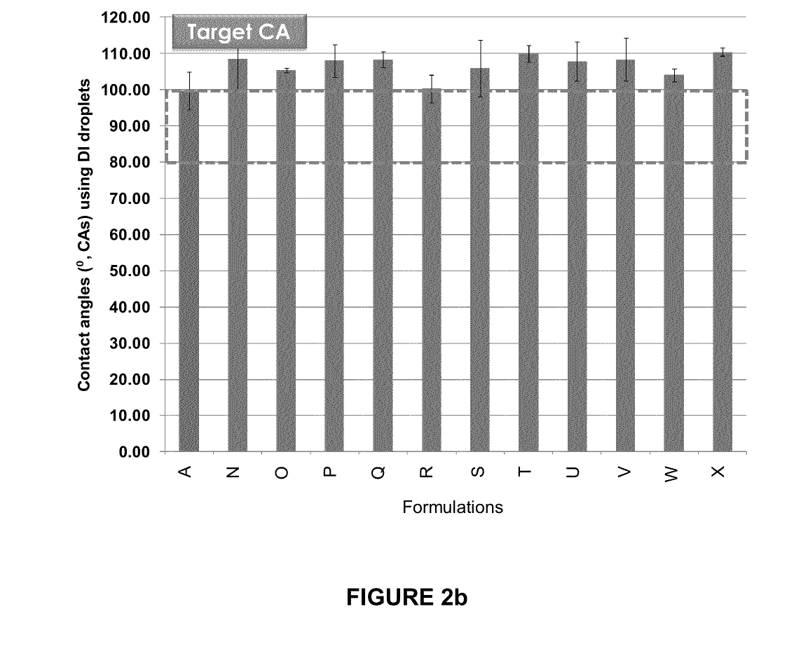

The contact angles of DI water on the modified TiNₓ surfaces are shown in FIGS. 2a and 2b with standard deviation bars. The target contact angle is between 80° and 100°.

### Example 2

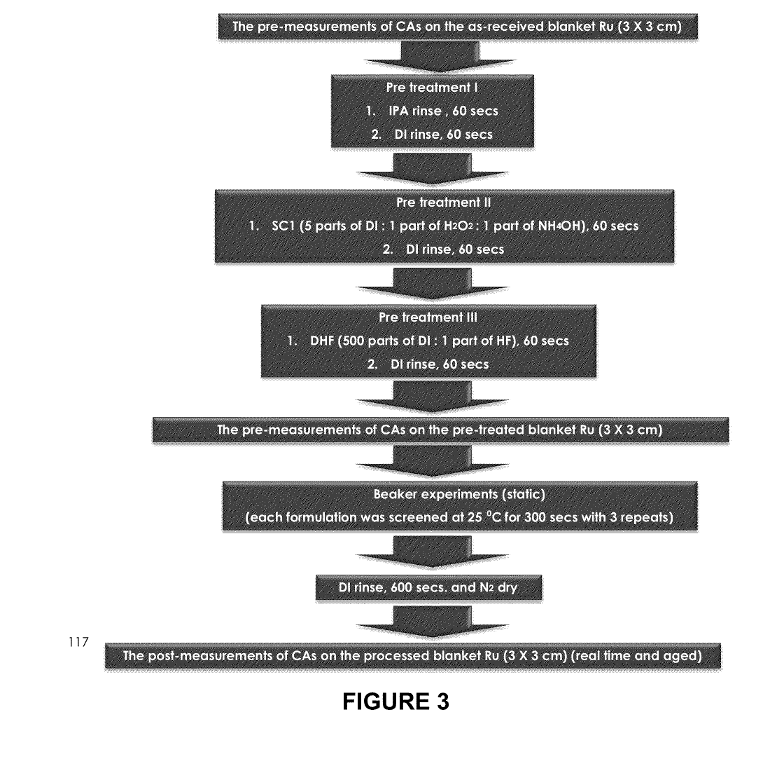

The general process flow for evaluating formulations on blanket Ru(ALD) substrates is shown in FIG. 3.

Additional formulations were prepared.

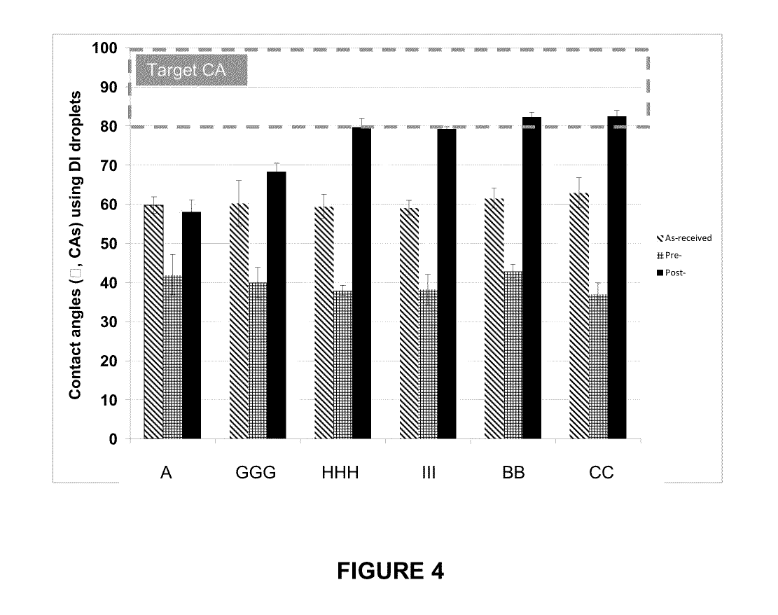

Formulation AA: 0.5 wt. % ODPA, 0.05 wt. % defoamer A RD28, 99.45 wt. % TPGME.
Formulation BB: 1.0 wt. % Dimethyldioctadecylammonium chloride; 0.1 wt % defoamer A RD28; 98.9 wt. % DPGME.
Formulation CC: 1.0 wt. % bis(hydrogenated tallow alkyl)dimethyl chloride; 0.1 wt % defoamer A RD28; 98.9 wt. % TPGME.
The contact angle of each Ru wafer was measured at four different times: (a) as received, (b) after pre-treatment steps I, II and III, (c) after pre-treatment I, II and III, immersion in the respective formulations and 10 min DI rinse, and (d) after pre-treatment I, II and III, immersion in the respective formulations, 10 min DI rinse, and aging at room temperature for 36 hr. The results are shown in FIG. 4.

### Example 3

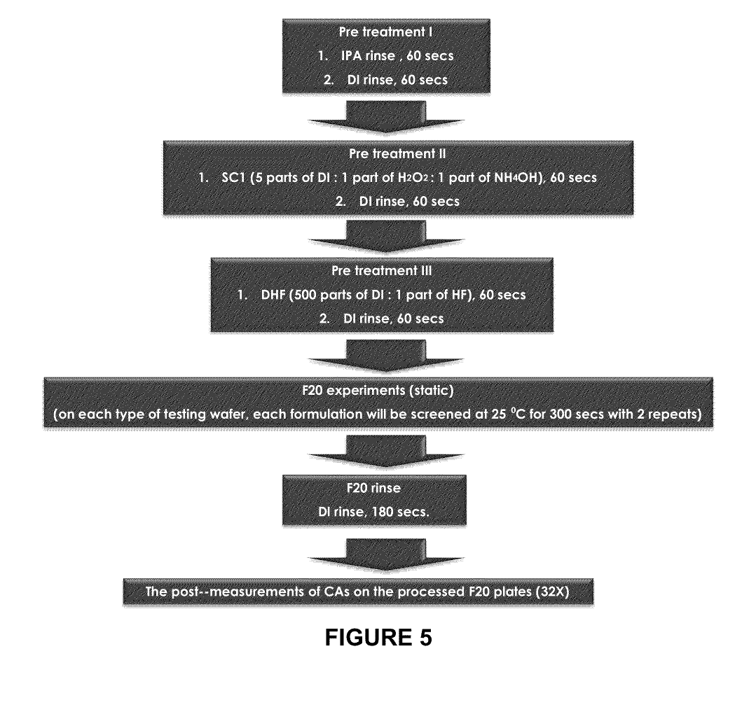

The general process flow for evaluating formulations on blanket polysilicon substrates using F20 experiments are shown in FIG. 5.

| | | | 0.2% | | |
|---|---|---|---|---|---|
| | | 0.3% Defoamer | surfactant in | | |
| | DMDODAC/ | A in DPGME/ | DPGME/ | | |
| Formulation | wt % | wt % | wt % | DPGME/wt % | water/wt % |
| DD | 0.9 | 0.09 | 0.01 (oleic) | 99 | — |
| EE | 0.9 | 0.09 | 0.01 | 99 | — |
| | | | (palmitic) | | |
| FF | 0.9 | 0.09 | 0.01 (lauric) | 99 | — |
| GG | 0.5 | 0.05 | 0.01 (oleic) | 79.44 | 20 |
| HH | 0.5 | 0.05 | 0.01 (oleic) | 89.44 | 10 |
| II | 0.5 | 0.05 | 0.01 (oleic) | 99.44 | — |
| JJ | 0.5 | 0.05 | 0.01 | 99.44 | — |
| | | | (palmitic) | | |
| KK | 0.5 | 0.05 | 0.01 (lauric) | 99.44 | — |
| LL | 0.1 | 0.01 | 0.01 (oleic) | 79.88 | 20 |
| MM | 0.1 | 0.01 | 0.01 (oleic) | 89.88 | 10 |
| NN | 0.1 | 0.01 | 0.01 (oleic) | 99.88 | — |
| OO | 0.1 | 0.01 | 0.01 | 79.88 | 20 |
| | | | (palmitic) | | |
| PP | 0.1 | 0.01 | 0.01 | 89.88 | 10 |
| | | | (palmitic) | | |
| QQ | 0.1 | 0.01 | 0.01 | 99.88 | — |
| | | | (palmitic) | | |
| RR | 0.1 | 0.01 | 0.01 (lauric) | 99.88 | — |

DMDODAC = dimethyldioctadecylammonium chloride

| | | 0.3% Defoamer | 0.2% | | |
|---|---|---|---|---|---|
| | Arquad 2HT-75/ | A in TPGME/ | surfactant in | | |
| Formulation | wt % | wt % | TPGME/wt % | TPGME/wt % | water/wt % |
| SS | 0.9 | 0.09 | 0.01 (oleic) | 99 | — |
| TT | 0.5 | 0.05 | 0.01 (oleic) | 79.44 | 20 |
| UU | 0.5 | 0.05 | 0.01 (oleic) | 89.44 | 10 |
| VV | 0.5 | 0.05 | 0.01 (oleic) | 99.44 | — |
| WW | 0.5 | 0.05 | 0.01 (lauric) | 99.44 | — |
| XX | 0.1 | 0.01 | 0.01 (oleic) | 79.88 | 20 |
| YY | 0.1 | 0.01 | 0.01 (oleic) | 89.88 | 10 |
| ZZ | 0.1 | 0.01 | 0.01 (oleic) | 99.88 | — |
| AAA | 0.1 | 0.01 | 0.01 | 79.88 | 20 |
| | | | (palmitic) | | |
| BBB | 0.1 | 0.01 | 0.01 | 89.88 | 10 |
| | | | (palmitic) | | |
| CCC | 0.1 | 0.01 | 0.01 | 99.88 | — |
| | | | (palmitic) | | |
| DDD | 0.1 | 0.01 | 0.01 (lauric) | 79.88 | 20 |
| EEE | 0.1 | 0.01 | 0.01 (lauric) | 89.88 | 10 |
| FFF | 0.1 | 0.01 | 0.01 (lauric) | 99.88 | — |

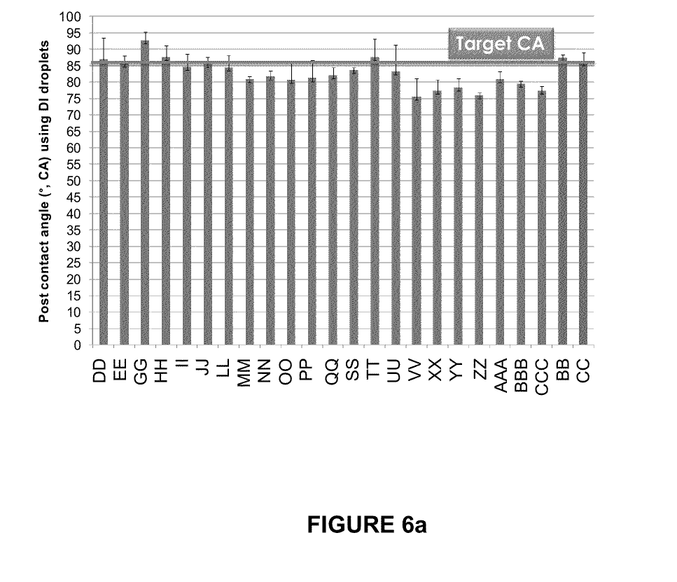

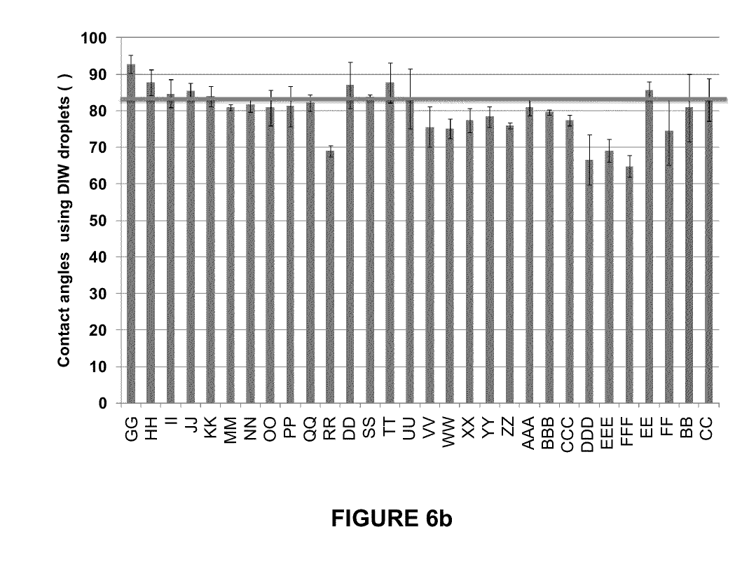

The contact angle of each polysilicon wafer was measured after pre-treatment I, II and III, immersion in the respective formulations for 5 min, and 10 min DI rinse. The results are shown in FIGS. 6a and 6b.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. A method of modifying a surface of a high aspect ratio feature, said method comprising:
contacting the surface of the high aspect ratio feature with an additive composition to produce a modified surface,
wherein forces acting on the high aspect ratio feature when a rinse solution is in contact with the modified surface are sufficiently minimized to prevent bending or collapse of the high aspect ratio feature at least during removal of the rinse solution or at least during drying of the high aspect ratio feature.

2. The method of claim 1, wherein the rinse solution in contact with the modified surface has a contact angle in a range from about 70 degrees to about 110 degrees.

3. The method of claim 1, wherein the surface comprises a material selected from the group consisting of gallium nitride, titanium nitride, amorphous carbon, tantalum nitrides, tungsten nitride, cobalt silicides, nickel silicides, polysilicon, silicon nitride, ruthenium-containing compounds selected from the group consisting of ruthenium, ruthenium oxide, ruthenium nitride, other ruthenium-containing compounds, and any combination thereof.

4. (canceled)

5. The method of claim 1, wherein the surface comprises a material selected from the group consisting of doped monocrystalline Si, undoped monocrystalline Si, doped polycrystalline Si, undoped polycrystalline Si, polysilicon, silicon dioxide, silicon nitride, and combinations thereof.

6. The method of claim 1, wherein the high aspect ratio feature comprises a material selected from the group consisting of titanium nitride, ruthenium, ruthenium oxide, ruthenium nitride, other ruthenium-containing compounds, and any combination thereof.

7. The method of claim 1, wherein the additive composition comprises a surfactant, at least one solvent, optionally at least one co-surfactant, optionally at least one buffering agent, optionally at least one defoaming agent, and optionally at least one stability agent.

8. (canceled)

9. (canceled)

10. The method of claim 7, wherein the surfactant comprises a species selected from the group consisting of (i) a straight-chained hydrocarbon group having 2-30 carbon atoms, (ii) a branched hydrocarbon group having 2-20 carbon atoms, (iii) two straight hydrocarbon groups having 2-30 carbon atoms, (iv) two branched hydrocarbon groups having 6-30 carbon atoms, (v) a species of formula (R¹)(R²)P(═O)(R³), where R¹, R² and R³ are independent from each other and are selected from the group consisting of hydrogen, hydroxyl, C₂-C₃₀ alkyls, C₂-C₃₀ alkenes, cycloalkyls, C₂-C₃₀ alkoxys, and combinations thereof, (vi) a species of formula (R¹R²R³R⁴)NX, wherein R¹, R², R³, and R⁴, are independent from one another and are selected from the group consisting of hydrogen, C₁-C₃₀ alkyls, C₂-C₃₀ alkenes, cycloalkyls, C₁-C₃₀ alkoxys, C₁-C₃₀ carboxylates, and any combination thereof, and wherein X is any anion having a −1 charge, (vii) a species of formula [(R¹)(R²)N]C(═O)(CR³R⁴)ₙC(═O)[N(R⁵)(R⁶)], wherein R¹, R², R³, R⁴, R⁵, and R⁶ are independent from one another and are selected from the group consisting of hydrogen, C₂-C₃₀ alkyls, C₂-C₃₀ alkenes, cycloalkyls, C₂-C₃₀ alkoxys, C₂-C₃₀ carboxylates, and any combination thereof, and wherein n=any integer from 1-12, (viii) a species of formula R¹C(═O)(OH), wherein R¹ is selected from C₁-C₃₀ alkyl or C₂-C₃₀ alkylene chains, (ix) R¹C(═O)(OH)(CH₂)ₙ(O═)(HO)CR², wherein R¹ or R² are independent from one another are selected from C₁-C₃₀ alkyl and C₂-C₃₀ alkylene chains, and n is an integer between 0 and 20, (x) a perfluorinated hydrocarbon group having 7-14 carbon atoms, and (xi) any combination thereof.

11. The method of claim 7, wherein the surfactant comprises at least one species selected from the group consisting of decylphosphonic acid, dodecylphosphonic acid, tetradecylphosphonic acid, hexadecylphosphonic acid, bis(2-ethylhexyl)phosphate, octadecylphosphonic acid, perfluoroheptanoic acid, prefluorodecanoic acid, trifluoromethanesulfonic acid, phosphonoacetic acid, dodecylbenzenesulfonic acid, dioctadecyl hydrogen phosphate, octadecyl dihydrogen phosphate, octadecylphosphonic acid, dodecenylsuccinic acid monodiethanol amide, octadecylphosphonic acid, lauric acid, palmitic acid, oleic acid, juniperic acid, 12 hydroxystearic acid and dodecylamine.

12. The method of claim 7, wherein the surfactant comprises at least one species selected from the group consisting of polyoxyethylene lauryl ether, dodecenylsuccinic acid monodiethanol amide, ethylenediamine tetrakis(ethoxylate-block-propoxylate)tetrol, polyoxyethylene polyoxypropylene glycol, polyoxypropylene sucrose ether, t-octylphenoxypolyethoxyethanol, polyoxyethylene (9) nonylphenylether (branched), polyoxyethylene sorbitol hexaoleate, polyoxyethylene sorbitol tetraoleate, polyethylene glycol sorbitan monooleate, sorbitan monooleate, alkyl-polyglucoside, ethyl perfluorobutyrate, 1,1,3,3,5,5-hexamethyl-1,5-bis[2-(5-norbornen-2-yl)ethyl]trisiloxane, monomeric octadecylsilane derivatives, siloxane modified polysilazanes, silicone-polyether copolymers, heptadecanefluorooctane sulfonic acid tetraethylammonium, stearyl trimethylammonium chloride, 4-(4-diethylaminophenylazo)-1-(4-nitrobenzyl)pyridium bromide, cetylpyridinium chloride monohydrate, benzalkonium chloride, benzethonium chloride benzyldimethyldodecylammonium chloride, benzyldimethylhexadecylammonium chloride, hexadecyltrimethylammonium bromide, dimethyldioctadecylammonium chloride, dodecyltrimethylammonium chloride, hexadecyltrimethylammonium p-toluenesulfonate, didodecyldimethylammonium bromide, di(hydrogenated tallow)dimethylammonium chloride, Tetraheptylammonium bromide,tetrakis(decyl)ammonium bromide, Aliquat® 336 and oxyphenonium bromide, dimethyldioctadecylammonium chloride, dimethyldihexadecylammonium bromide, sodium polyoxyethylene lauryl ether, sodium dihexylsulfosuccinate, dicyclohexyl sulfosuccinate sodium salt, sodium 7-ethyl-2-methyl-4-undecyl sulfate, SODOSIL RM02, phosphate fluorosurfactants, ethylene oxide alkylamines, N,N-dimethyldodecylamine N-oxie, sodium cocaminpropinate, 3-(N,N-dimethylmyristylammonio)propanesulfonate, (3-(4-heptyl)phenyl-3-hydroxypropyl)dimethylammoniopropanesulfonate, guanidine hydrochloride, tetrabutylammonium trifluoromethanesulfonate, and combinations thereof.

13. The method of claim 7, wherein at least one solvent is a compound of formula R¹R²R³C(OH), where R¹, R² and R³ are independent from each other and are selected from to the group consisting of hydrogen, C₂-C₃₀alkyls, C₂-C₃₀alkenes, cycloalkyls, C₂-C₃₀alkoxys, and combinations thereof.

14. The method of claim 7, wherein the at least one solvent comprises a species selected from the group consisting of water, methanol, ethanol, isopropanol, butanol, pentanol, hexanol, 2-ethyl-1-hexanol, heptanol, octanol, ethylene glycol, propylene glycol, butylene glycol, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, 2,3-dihydrodecafluoropentane, ethyl perfluorobutylether, methyl perfluorobutylether, alkyl carbonates, alkylene carbonates, 4-methyl-2-pentanol, dense fluid, and combinations thereof.

15. The method of claim 7, comprising the co-surfactant polyethylene glycol/polypropylene glycol co-polymer or a buffering agent.

16. The method of claim 7, comprising additive composition process temperatures between about 20° C. and about 120° C. and process time between about 60 to about 6000 seconds.

17. (canceled)

18. The method of claim 1, wherein the rinse solution comprises at least one solvent selected from the group consisting of water, methanol, ethanol, isopropanol, butanol, ethylene glycol, propylene glycol, butylene glycol, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether (DPGME), tripropylene glycol methyl ether (TPGME), dipropylene glycol dimethyl ether, dipropylene glycol ethyl ether, propylene glycol n-propyl ether, tripropylene glycol n-propyl ether, propylene glycol n-butyl ether, dipropylene glycol n-butyl ether, tripropylene glycol n-butyl ether, propylene glycol phenyl ether, 2,3-dihydrodecafluoropentane, ethyl perfluorobutylether, methyl perfluorobutylether, alkyl carbonates, alkylene carbonates, 4-methyl-2-pentanol, and combinations thereof.

19. The method of claim 1, further comprising rinsing the surface prior to contacting said surface with the additive composition.

20. The method of claim 1, further comprising rinsing the modified surface with a rinse solution.

21.-23. (canceled)

24. The method of claim 1, further comprising drying the modified surface subsequent to the rinse.

25. (canceled)

26. The method of claim 1, wherein the contact angle of the modified surface at rinse time t=x is no greater than about +/− ten degrees different from the contact angle of the modified surface at rinse time t=0, wherein x is in a range from about 60 sec to about 6000 sec.

27. (canceled)

28. (canceled)

29. An article of manufacture comprising an additive composition and a modified surface, wherein the additive composition comprises at least one surfactant, at least one organic solvent, and optionally at least one co-surfactant, optionally at least one defoaming agent, optionally at least one buffering agent, and optionally at least one stability agent.

30. An article of manufacture comprising a modified high aspect ratio surface, said modified surface comprising adsorbed surfactant compounds and a rinse solution, wherein said composition in contact with the modified surface has a contact angle in a range from about 70 degrees to about 110 degrees, and wherein the modified high aspect ratio surface comprises a material selected from the group consisting of titanium nitride, amorphous carbon, tantalum nitrides, tungsten nitride, cobalt silicides, nickel silicides, polysilicon, silicon nitride, ruthenium-containing compounds selected from the group consisting of ruthenium, ruthenium oxide, ruthenium nitride, other ruthenium-containing compounds, and any combination thereof.

31. (canceled)
